(19) United States
(12) Patent Application Publication
(10) Pub. No.: US 2018/0208151 A1
(43) Pub. Date: Jul. 26, 2018

(54) ELECTRONIC SEATBELT

(71) Applicant: Ford Global Technologies, LLC, Dearborn, MI (US)

(72) Inventors: Alvaro Jimenez Hernandez, Miguel Hidalgo (MX); Oswaldo Perez Barrera, Texcoco (MX)

(73) Assignee: Ford Global Technologies, LLC, Dearborn, MI (US)

(21) Appl. No.: 15/415,475

(22) Filed: Jan. 25, 2017

(51) Int. Cl. B60R 22/32; B60R 22/48; G08C 17/02

(52) U.S. Cl. CPC B60R 22/325; B60R 2022/4816; G08C 17/02; B60R 22/48

(57) ABSTRACT

A computer that can be programmed to, among other things, receive a message associated with an electronic seatbelt buckle in a vehicle from one of: a vehicle switch, a mobile device, or a remotely-located server, and in response to receiving the message, actuate the buckle to release a clip therefrom.

### BACKGROUND

Seatbelt mechanisms include a latch and a buckle and are adapted to restrain a vehicle passenger in the event of a vehicle collision. In conventional electronic systems, the mechanism is energized to inhibit the passenger from unfastening the latch from the buckle (e.g., the mechanism is energized to electronically lock the passenger in a vehicle seat). And when, for example, once the mechanism is no longer energized, the passenger can unfasten the latch and remove it from the buckle.

### BRIEF DESCRIPTION OF THE DRAWINGS

FIG. 1 illustrates an electronic seatbelt system for a vehicle.

FIG. 2 is a perspective view of a seatbelt clip and a seatbelt buckle.

FIG. 3 is a partial sectional view of the seatbelt buckle in a coupled state.

FIG. 4 is a partial sectional view of the seatbelt buckle, after being electronically actuated, changing to an uncoupled state.

FIG. 5 is a state diagram illustrating the various states of the seatbelt buckle shown in FIGS. 2-4.

FIG. 6 is a flowchart illustrating an example process of determining when to electronically actuate the seatbelt buckle.

### DETAILED DESCRIPTION

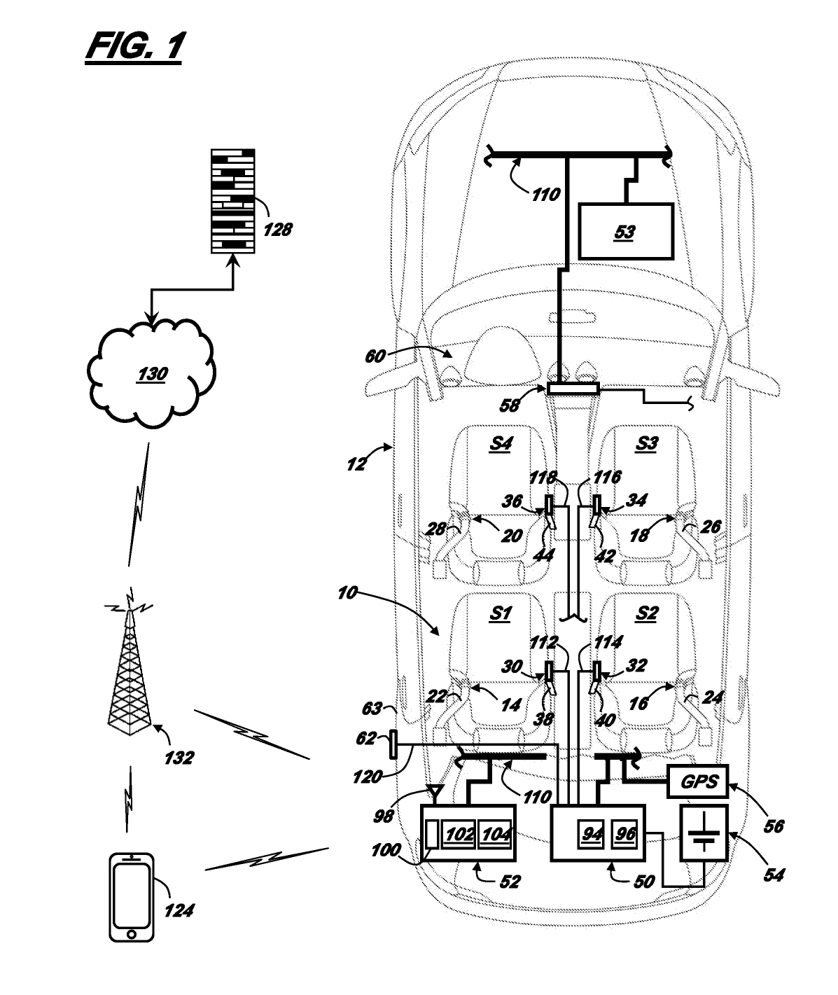

With reference to the figures, wherein like numerals indicate like parts throughout the several views, an electronic seatbelt system 10 in a vehicle 12 (FIG. 1) is disclosed; the system 10 includes one or more seatbelt clips and corresponding seatbelt buckles. Using the seatbelt system 10, a user may insert manually a clip into a respective buckle so that the clip/buckle pair is in a coupled stated (i.e., the clip is locked within the buckle). Then, in accordance with programming instructions executed by an onboard computer and at a suitable time, the computer may provide an instruction that results in an electrical signal being provided to the buckle to release the clip from the buckle (e.g., to an uncoupled state (i.e., the clip no longer being locked within the buckle)). According to one example, the computer may be programmed to determine an emergency event (e.g., based on one or more conditions—e.g., such as deployment of vehicle airbags), and based on this determination, the computer may electronically actuate the buckle to thereby release the clip, as will be described in greater detail below. In other instances, the computer may receive an instruction from another electronic device or switch located at the vehicle 12 (or even located remotely therefrom), and based on this instruction, the computer may be programmed to electronically actuate the buckle to release the associated clip. And in at least one example, the computer may be programmed to: receive data from a sensor located on the buckle itself, analyze this data, and based on the analysis, determine whether to electronically actuate the buckle to thereby release the clip. Still other examples will be discussed below.

Referring to FIG. 1, the vehicle 12 may be a passenger car or any other suitable vehicle. For example, vehicle may be a truck, sports utility vehicle (SUV), recreational vehicle, a bus or train (e.g., a school bus), marine vessel, aircraft, or the like that includes the electronic seatbelt system 10. Vehicle 12 may be operated in any one of a number of autonomous modes. In at least one example, vehicle 12 may operate as an autonomous taxi, autonomous school bus, or the like—e.g., operating in a fully autonomous mode (e.g., a level 5), as defined by the Society of Automotive Engineers (SAE) (which has defined operation at levels 0-5). For example, at levels 0-2, a human driver monitors or controls the majority of the driving tasks, often with no help from the vehicle 12. For example, at level 0 (“no automation”), a human driver is responsible for all vehicle operations. At level 1 (“driver assistance”), the vehicle 12 sometimes assists with steering, acceleration, or braking, but the driver is still responsible for the vast majority of the vehicle control. At level 2 (“partial automation”), the vehicle 12 can control steering, acceleration, and braking under certain circumstances without human interaction. At levels 3-5, the vehicle 12 assumes more driving-related tasks. At level 3 (“conditional automation”), the vehicle 12 can handle steering, acceleration, and braking under certain circumstances, as well as monitoring of the driving environment. Level 3 may require the driver to intervene occasionally, however. At level 4 (“high automation”), the vehicle 12 can handle the same tasks as at level 3 but without relying on the driver to intervene in certain driving modes. At level 5 (“full automation”), the vehicle 12 can handle all tasks without any driver intervention.

The electronic seatbelt system 10 of vehicle 12 may be used in any of the autonomous modes described above and may include: one or more seatbelt clips or latches 14, 16, 18, 20 (each clip coupled to a respective first seatbelt webbing 22, 24, 26, 28), one or more seatbelt buckles 30, 32, 34, 36 (each buckle coupled to a respective second seatbelt webbing 38, 40, 42, 44 and each corresponding to a respective vehicle seat S1, S2, S3, S4), a computer 50 for selectively controlling actuation of the buckles 30-36, a computer 52 for communicating with extra-vehicle devices, an auxiliary power source 54 to provide backup power to the seatbelt system 10, a positioning device 56 (e.g., such as a global positioning system (GPS) or global navigation satellite system (GLONASS)), a human-machine interface (HMI) 58 located within the vehicle 12 (e.g., located at an instrument panel 60), and at least one emergency switch 62 (e.g., assessable by persons located outside vehicle 12 (e.g., outer region or exterior surface thereof 63)). As will be apparent from the discussion below, not all of the elements of the system 10 described above are required (i.e., some elements may not be used in all examples). Similarly, any of the elements described herein can be used singly or in combination with one another in any suitable example.

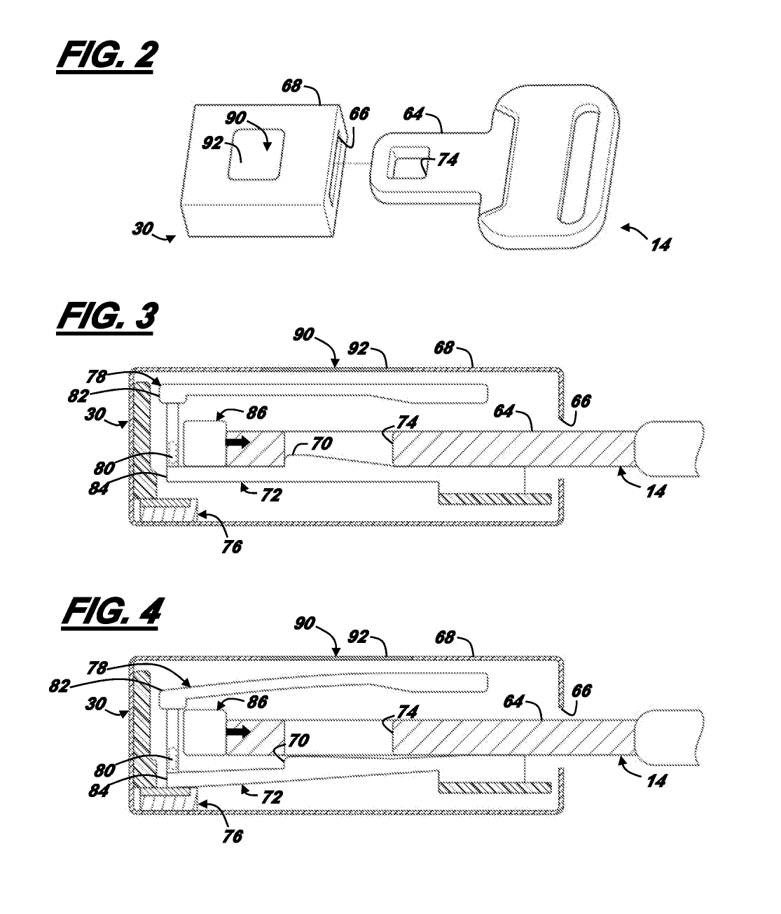

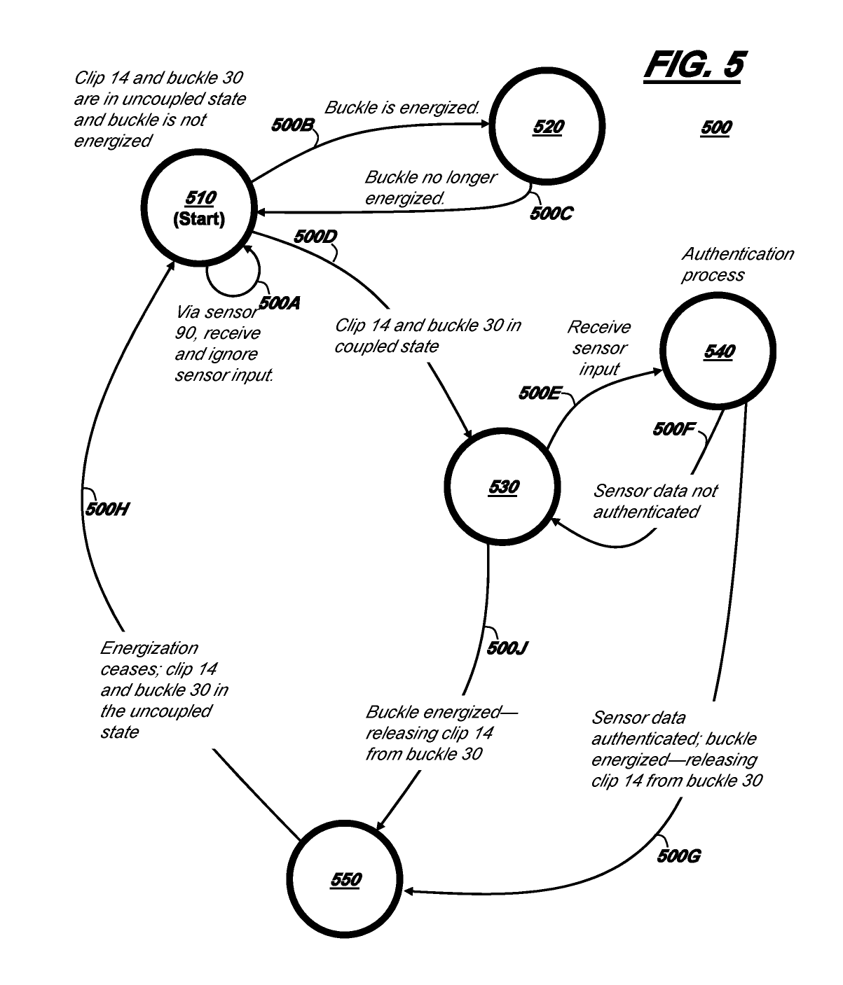

Each seatbelt clip 14-20 and each corresponding buckle 30-36 may be identical; therefore, only one pair (14, 30) will be described for illustrative purposes (see FIGS. 2-4). More particularly, FIG. 3 illustrates a coupled state of the pair 14, 30, and FIG. 4 illustrates the buckle being electronically actuated to release the clip 14 (e.g., to an uncoupled state). In general, a tongue 64 of the clip 14 may be inserted manually into a slotted opening 66 of a housing 68 of the buckle 30, and a locking feature 70 carried by a lock plate 72 within the housing 68 may retain the clip 14. For example, in the non-limiting example shown in FIGS. 2-4, the locking feature 70 is located within an opening 74 of the tongue 64 to retain or lock the clip 14 in the coupled state. As will be explained below, when computer 50 selectively actuates buckle 30, an attracting member 76 (e.g., such as an electro-magnet) within the buckle 30 may be energized (e.g., electricity generating a magnetic field). And this magnetic field may attract an actuator 78 in the buckle 30 which carries an attractable element 80 (e.g., a magnetic core—e.g., comprised of ferromagnetic material). In the illustrated example, in response to the magnetic field, a free end 82 of the actuator 78 resiliently may flex toward the electro-magnet 76 and drive a free end 84 of the lock plate 72 in the same direction (e.g., toward the electro-magnet 76). As a result, the lock plate 72 also resiliently may flex thereby displacing the locking feature 70 from the opening 74 in the clip 14, and thereafter, an ejector mechanism 86 (e.g., which is biased to drive the clip 14 toward the slotted opening 66), may drive the tongue 64 out of the buckle 30 (e.g., to the uncoupled state). This arrangement of the clip 14 and buckle 30 is merely one example illustrated here for exemplary purposes only; other examples exist wherein the seatbelt clip 14 is released when the buckle 30 is actuated by an electrical signal or the like.

FIGS. 2-4 also illustrate that the buckle 30 may include an optional sensor 90 having a sensing surface 92 facing outwardly of the buckle housing 68. Sensor 90 can be an electronic device adapted for touch, tactile, contact, or proximity sensing. According to one non-limiting example of sensor 90 is a biometric sensor which is adapted to sense at least a portion of a human's fingerprint or fingerprint pattern by the user touching surface 92 thereof. In another example, the sensor 90 is a pressure sensor adapted to provide an electrical output corresponding to the amount of pressure applied by a user. Other examples also exist. As will be described below, the sensor 90 may be coupled to and may provide electrical output to computer 50 which the computer may use to determine whether to electronically actuate the buckle 30.

Computer 50 shown in FIG. 1 may be configured with instructions to selectively actuate the seatbelt buckles 30-36. In one non-limiting example, computer 50 is a restraint control module (RCM); however, this is not required. In general, computer 50 includes a processor or processing circuit 94 coupled to computer memory 96. For example, processor 94 can be any type of device capable of processing electronic instructions, non-limiting examples including a microprocessor, a microcontroller or controller, an application specific integrated circuit (ASIC), etc.—just to name a few. Processor 94 may be dedicated to computer 50, or it may be shared with other computers, vehicle systems, and/or subsystems. In general, computer 50 may be programmed to execute digitally-stored instructions, which may be stored in memory 96, which enable the computer 50, among other things, to electronically actuate the electro-magnet 76 in the buckle 30 and (when applicable) to analyze sensor data received from the sensor 90.

Memory 96 may include any non-transitory computer usable or readable medium, which may include one or more storage devices or articles. Exemplary non-transitory computer usable storage devices include conventional computer system RAM (random access memory), ROM (read only memory), EPROM (erasable, programmable ROM), EEPROM (electrically erasable, programmable ROM), as well as any other volatile or non-volatile media. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read. As discussed above, memory 96 may store one or more computer program products which may be embodied as software, firmware, or the like.

Computer 52 may be configured to wireles sly communicate with other electronic devices—e.g., using cellular technology, short range wireless communication technology, or the like (e.g., using one or more antennas 98 and one or more wireless chipsets 100). Computer 52 also may have a processor or processing circuit 102 and computer memory 104 coupled to the processor 102—and in at least one example, the hardware 102, 104 may be identical to that described above with respect to computer 50; therefore, the processor 102 and memory 104 will not be re-described here. However, the instructions stored in memory 104 and executable by processor 102 may differ in at least some respects. For example, computer 52 may be programmed to send and receive messages using a cellular protocol (e.g., such as LTE, GSM, CDMA, etc.), and, e.g., computer 52 may be programmed to send and receive messages using any suitable short range wireless communication protocol (e.g., such as Wi-Fi, Wi-Fi Direct, Bluetooth, Bluetooth Low Energy (BLE), Near-Field Communication (NFC), etc.). As will be described more below, computer 52 may provide certain messages—which were received via wireless communication to computer 50 so that computer 50 may determine whether to selectively actuate at least one of the buckles 30-36.

Computers 50, 52 may communicate via any suitable wired or wireless network connection 110. In at least one example, the connection 110 is a controller area network (CAN) bus, Ethernet, Local Interconnect Network (LIN), a combination thereof, or the like. However, this is not required. For example, connection 110 could include one or more discrete connections instead. In FIG. 1, a number of discrete connections 112, 114, 116, 118 are also illustrated between computer 50 and the buckles 30-36, respectively—enabling computer 50 to electronically actuate the respective buckle. Thus, these connections 112-118 may provide power, data, or a combination thereof between computer 50 and buckles 30-36. In at least one example, these respective connections 112-118 may enable respective sensors located at least buckle 30-36 (e.g., such as sensor 90) to provide sensor data to computer 50 for analysis.

Auxiliary power source 54 is shown coupled to computer 50. As used herein, auxiliary power source 54 may be any suitable electrical energy storage device located onboard vehicle 12 that is in addition to a primary power source (e.g., a vehicle battery, not shown), wherein source 54 also stores electrical energy when the vehicle 12 is in an ignition OFF state. It may be a lithium-type battery, a capacitor-type battery, a lead-acid-type (PbA) battery, a combination thereof, etc. In FIG. 1, it is shown coupled to computer 50; however, this is not required; e.g., alternatively, in addition to this coupling, it could be switchably coupled to each of the buckles 30-36. As will be described more below, power source 54 may be used to electronically actuate one or more of the buckles 30-36 during a failure of the primary power source (or as a result of a failed connection (e.g., an electrical short) between the primary power source and at least a portion of the electronic seatbelt system 10). Thus, the power source 54 may serve a redundancy role or may be primarily used by computer 50 actuate buckle 30.

The positioning device 56—which also may be coupled to network connection 110—includes any suitable computing device which can provide global and/or local location data to computer 50. For example, positioning device 56 may receive location data (e.g., such as latitude and longitude (LAT/LONG) coordinate data) from one or more satellites. Non-limiting satellite types and location systems include GPS and GLONASS.

The human-machine interface (HMI) 58—which also may be coupled to network connection 110—may include any suitable input and/or output devices such as switches, knobs, controls, etc. For example, in one non-limiting example, HMI 58 may comprise an interactive touch screen or display which provides information (e.g., including text, images, etc.) to a vehicle user; further, the HMI 58 may function as an input device permitting the user to make selections, enter data, scan or read user fingerprints, etc. by touching the screen. Non-touch screen implementations are also possible; thus, touch input is merely one example. For example, HMI 58 may accept input enabling a user to selectively actuate buckles 30-36, or HMI 58 may accept destination data input—indicating where a user desires the vehicle 12 to travel. Thus, the HMI 58 may be used to provide destination data via a message to computer 50 so that computer 50 may electronically actuate seatbelt buckles 30-36 upon reaching a predetermined destination, as will be explained in greater detail below. As used herein, destination data is predetermined location data provided by a vehicle user, a remote server (e.g., such as server 128 discussed below), or a mobile device (e.g., such as device 124 discussed below); destination data represents a location (e.g., an address, LAT/LONG coordinates, etc.) to which the vehicle 12 is driving. It may be an end point (e.g., wherein the vehicle 12 powers OFF), or it may be a mid- or waypoint (e.g., a location wherein the vehicle 12 temporarily stops before proceeding to another destination).

Emergency switch 62 is shown coupled to computer 50 via a discrete connection 120. As will be explained below, switch 62 may be actuated under certain emergency situations to electronically actuate at least one (e.g., or all) buckles 30-36 so that any user coupled by the respective clips 14-20 may egress the vehicle 12.

FIG. 1 also illustrates a number of other electronic devices which are generally known in the art; namely, mobile device 124, remotely-located computer server 128, a land communications network 130, and a wireless communications network 132. In some examples, mobile device 124 may include an electronic device capable of cellular voice and/or data calls across a wide geographic region—e.g., facilitated by the wireless communications network 132. Mobile devices 124 typically comprise at least one processor, memory, and an input/output interface—and may include cellular and/or short range wireless chipsets, etc. Non-limiting examples of mobile device 124 include a cellular telephone, a personal digital assistant (PDA), a Smart phone, a laptop or tablet computer having two-way communication capabilities (e.g., via a land and/or wireless connection), a netbook computer, a telematics device (e.g., located in another vehicle), and the like. The user of mobile device 124 may or may not be the same as the user of vehicle 12. For example, wireless communication to vehicle 12 (or more specifically to computer 50 via computer 52) may be carried out while the mobile device 124 is within the vehicle 12 or when it is remotely located therefrom.

The remote server 128 may be any suitable computer or computing system having one or more processors and memory which may be linked to one or more computer databases—the server 128 may be specially-configured to communicate with vehicles operating in an autonomous mode, e.g., such as vehicle 12. For example, server 128 may perform a number of backend functions for vehicles operating as autonomous vehicle taxis, autonomous vehicle school buses, etc. Non-limiting examples of backend functions including providing infotainment and/or entertainment services, providing emergency services, providing routing and/or destination data, etc. In at least one example, as will be explained more below, server 128 can provide an instruction to computer 50 via networks 130, 132 and via computer 52 instructing the computer 50 to electronically actuate one or more seatbelt buckles 30-36 (e.g., in an emergency situation, such as following a vehicle collision). Other communications associated with the electronic seatbelt system 10 are also possible.

The land communication network 130 may include any wired network coupled to the wireless communication network 132 enabling connectivity to public switched telephone network (PSTN) such as that used to provide hardwired telephony, packet-switched data communications, internet infrastructure, and the like. And wireless communication network 132 enabling cellular telephone communication over a wide geographic region; network 132 includes any suitable cellular infrastructure such as so-called eNodeBs, serving gateways, base station transceivers, etc. Further network 132 may utilize any suitable existing or future cellular technology (e.g., LTE, CDMA, GSM, etc.). Both communication networks 130, 132 are generally known in the art and will not be described further herein.

Turning now to a state diagram 500 shown in FIG. 5, the state diagram illustrates the various states within which any one of the seatbelt buckles 30-36 could be; further, it should be appreciated that one or more of buckles 30-36 could be in different states at any given time. Since each of the seatbelt buckles 30-36 can operate identically, only one seatbelt buckle (30) will be described for illustrative purposes.

The state diagram begins in state 510, wherein the clip 14 and buckle 30 are in the uncoupled state, and computer 50 is not electronically actuating buckle 30. In this state, sensor 90 may receive an input (e.g., via surface 92) [500A]; however, such input may be ignored and no state change may occur.

If during state 510, buckle 30 could be electronically actuated (e.g., electro-magnet 76 could be energized) [500B], then the state of buckle 30 may change to state 520. However, once buckle 30 is no longer energized, the state may revert to state 510 again [500C]. This may occur, e.g., if the computer 50 transmits a global electronic actuation signal—i.e., computer 50 electronically actuates all seatbelt buckles 30-36 concurrently. In this instance, the buckles 30-36 may be in various states (e.g., some coupled, some uncoupled). Thus, e.g., if buckle 30 is in an uncoupled state at the time, such an actuation temporarily may energize electro-magnet 76 and change its state from state 510 to 520 (followed by a reversion again to state 510).

When the clip 14 is inserted into and coupled with buckle 30 [500D], the state of the buckle 30 may change from state 510 to state 530. Thus, in state 530, the clip 14 and buckle 30 may be in the coupled state, the buckle 30 may not be energized, and no sensor data may be received at computer 50 from sensor 90.

The state of buckle 30 may change to state 540 if a sensor input is received via sensor 90 [500E]. State 540 may include computer 50, as described below, attempting to authenticate sensor data received from sensor 90. For example, where sensor 90 is a biometric sensor, the sensor data may include biometric data (e.g., such as fingerprint data), and computer 50 may determine whether to authenticate the input based on a comparison of the sensor data to stored sensor data parameters (e.g., such as fingerprint information stored in memory 96). As used herein, fingerprint data includes finger and thumb-print data, partial- and/or whole print data. More particularly, fingerprint data may be a digital scan or other representation of a human user's fingerprint. If the sensor data is not authenticated [500F], then the state of buckle 30 may revert to state 530 again.

Other examples of authentication could include computer 50 receiving sensor data [500E] (e.g., embodied here as pressure data) from sensor 90, e.g., when sensor 90 is embodied as a pressure sensor. As used herein, pressure data is electrical data (e.g., digital or analog data) received from sensor 90 which data is associated with a pressure applied to the sensor surface 92. In at least one example, authentication occurs when the pressure data indicates an applied pressure greater than a sensor data parameter stored in memory 96 (e.g., a pressure threshold). For example, the threshold may be associated with a pressure which could not be applied by a child (e.g., less than 5 years of age or the like) but which could be applied by an adult. In this manner, when computer 50 determines that the pressure data indicates a pressure greater than the threshold, computer 50 may authenticate the pressure data and thereafter electronically actuate the buckle 30. If in state 540, computer 50 does not authenticate the pressure data [500F], then the state of buckle 30 reverts back to state 530.

Regardless of how authentication occurs, if the sensor data is authenticated in state 540, then another state change occurs (to state 550). Here, the electro-magnet 76 of buckle 30 may be energized by computer 50 and consequently, the clip 14 may be released from the buckle 30 by the ejector mechanism 86 (to the uncoupled state again), as described above. The energization of electro-magnet 76 may be temporary (e.g., for less than one second, for 1-3 seconds, etc.).

Once the buckle 30 is no longer being electronically actuated (and with the clip 14 no longer coupled thereto), the state of buckle reverts to state 510 again [500H]. Diagram 500 also illustrates that the state of buckle 30 may proceed from state 530 directly to state 550—e.g., the buckle 30 may be energized without authentication [500J]. This may occur for a number of reasons—e.g., including but not limited to computer 50 determining an emergency event, computer 50 receiving an instruction within a wireless message from mobile device 124 or server 128, a message from emergency switch 62 (e.g., in the form of an electronic trigger signal), etc.

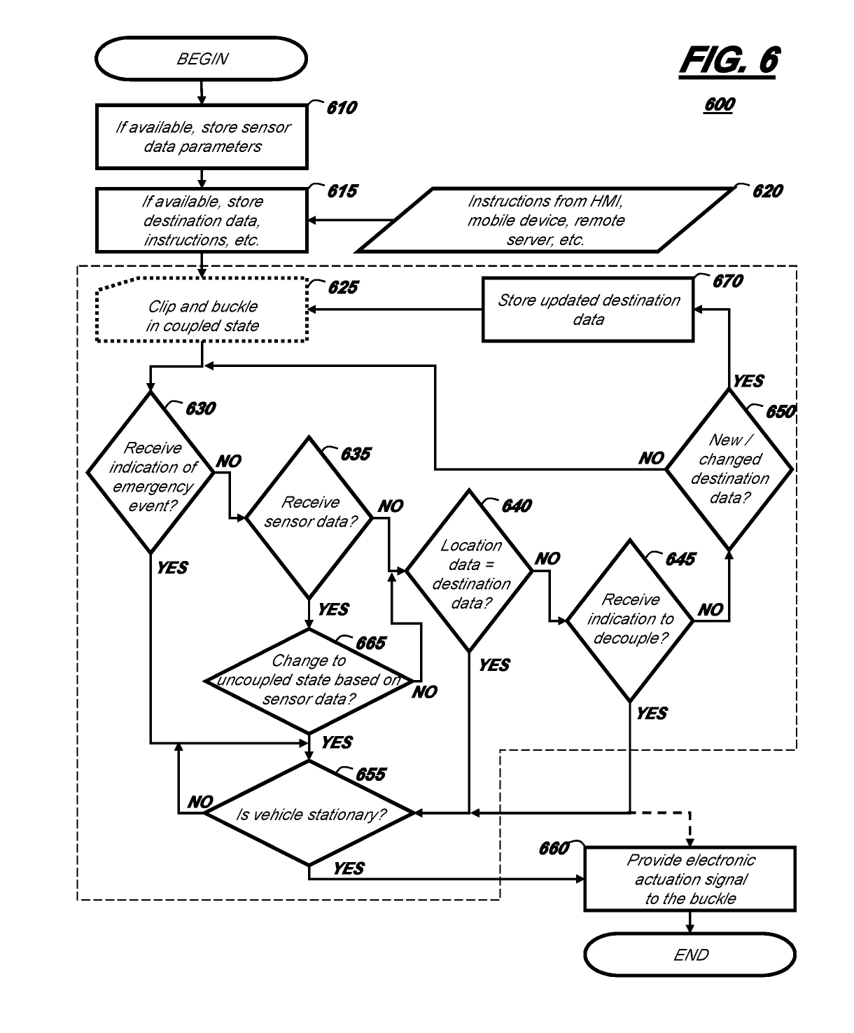

Turning now to FIG. 6, a process 600 is shown that may be carried out by computer 50 (and/or any other suitable computer onboard vehicle 12). The process 600 may include determining at computer 50 whether to electronically actuate one or more of the buckles (30-36)—i.e., whether to send a suitable electrical signal or otherwise cause such a signal to be sent to the respective buckle 30-36 to thereby energize the electro-magnet 76 therein causing the buckle to release the respective seatbelt clip 14-20. Again, clip 14 and buckle 30 are illustrative.

The illustrated process 600 begins before the clip 14 and buckle 30 are in the coupled state. In block 610, computer 50 may store sensor data parameters. A couple of non-limiting examples were discussed above—e.g., fingerprint data (e.g., one or more fingerprints of one or more authorized users) and one or more pressure thresholds; other examples also exist. Such parameters may be provided to computer 50 via the HMI 58, mobile device 124, remote server 128, etc.

Process 600 also may include block 615 for storing other data in memory 96 of computer 50—e.g., storing destination data, instructions, etc. Blocks 610 and 615 may occur in any order or at least partially concurrently. FIG. 6 illustrates block 620 providing input to block 615. Non-limiting examples of input in block 620 include receiving instructions from HMI 58, from mobile device 124, from remote server 128, and the like. These instructions may be stored in memory 96 and may be used by computer 50 to trigger an electronic actuation of buckle 30, as described below.

In block 625, the clip 14 is inserted into buckle 30 and this block corresponds with state 530 (discussed above). Coupling the clip 14 and buckle 30 may be carried out by a user (and thus is shown in phantom); e.g., a human may manually insert clip 14 into the slotted opening 66 of buckle 30 until the locking feature 70 is engaged with the opening 74 of clip 14. However, this coupling process is not intended to be limiting—e.g., in at least one implementation, the clip 14 could be inserted into buckle 30 by a computer or other electronic mechanism.

Computer 50 may be programmed to provide an electronic actuation to buckle 30 according to a number of scenarios—as shown in blocks 630, 635, 640, 645, 650, as described below. These blocks 630-650 may occur in different sequences, depending on the programming of computer 50. Or in some instances, one or more of these blocks 630-650 may be omitted.

In block 630 which follows block 625, computer 50 may determine whether it has received an indication of an emergency event. For example, it may receive data via bus 110 from other computers or modules located in the vehicle 12 indicating an impact or collision. For example, computer 50 could receive data indicating that the vehicle airbags have deployed. Or the computer 50 could receive braking system data or accelerometer data—e.g., indicating a sudden deceleration. If such indication is received, process 600 proceeds to block 655; however, if no such indication is received, then process 600 may proceed to block 635.

In block 635, computer 50 determines whether it is receiving sensor data from sensor 90. Again, non-limiting examples of this sensor data include fingerprint data, pressure data, etc. If such sensor data is being received, then process 600 may proceed to block 665; else it may proceed to block 640. In block 665, the computer determines whether to provide an electronic actuation of the buckle 30 based on the sensor data; this may be similar to the authentication description set forth above (therefore, this will not be re-described here). If the sensor data is authenticated, then process 600 may proceed from block 665 to block 655.

In block 640, the computer 50 may determine whether its present location data (e.g., received from positioning device 56 matches destination data previously stored by computer 50 in block 615. For example, present LAT/LONG coordinates may be compared to those entered by a user into the HMI 58 or into mobile device 124—and ultimately stored by computer 50. As used herein, matching destination and location data may mean that the vehicle is within a threshold distance of destination coordinates (e.g., within 500 feet or the like). If the location data matches the destination data, process 600 may proceed to block 655; however, if no such match is determined, then process 600 may proceed to block 645.

In block 645, the computer 50 may determine whether it has received an indication to decouple the clip 14 and buckle 30. This indication may take the form of a command, a message, an electrical signal, or the like and may come from a number of different sources. For example, it may be received by computer 50 via a message sent from HMI 58 over bus 110. Or a message comprising an instruction may be received by computer 50 via a wireless data communication sent from mobile device 124 or server 128 (e.g., received by computer 52 and sent to computer 50 via bus 110). Or the indication may be received by computer 50 as an electrical signal—e.g., as a result of emergency switch 62 being actuated. These are just a few examples; others exist. If in block 645 an indication to decouple the clip 14 and buckle 30 is received, then process 600 may proceed to block 655; however, if no such indication is received, then process 600 may proceed to block 650.

In block 650, the computer 50 may determine whether new destination data is available—e.g., received via HMI 58, mobile device 124, server 128, etc. In some examples, no previous destination data may have been stored in memory 96 (e.g., following the most recent vehicle ignition event); thus, computer 50 may interpret this destination data as new. In another example, destination data was previously stored in computer 50 and the new destination data is merely a change or update. If in block 650 a new destination data is available, then process 600 may proceed to block 670; however, if no such indication is received, then process 600 may loop back to block 630 and repeat. In block 670, computer 50 stores the updated or new destination data in memory 96 and then may proceed to block 630 (repeating the portion of the process 600 which follows).

As described above, computer 50 may proceed to block 655 from a number of different blocks: e.g., from block 630, from block 640, from block 645, or from block 665. In block 655, the computer 50 may determine whether the vehicle 12 is stationary. For example, computer 50 may determine this independently (e.g., via sensors coupled to computer 50 and the vehicle wheels, powertrain, etc.), or the computer 50 may receive this information from other onboard vehicle computer(s).

Regardless of how computer 50 makes the determination in block 655, computer 50 may proceed to block 660 when it determines the vehicle 12 is stationary. When it determines otherwise, the process may loop back and repeat block 655 until the vehicle 12 is determined to be stationary. For example, to illustrate, if the vehicle airbags have deployed (e.g., detected in block 630), then it is presumed the vehicle 12 will eventually become stationary, and when this occurs process 600 may proceed to block 660. Similarly, if computer 50 determines that stored destination data matches the current vehicle location data of the vehicle (e.g., block 640), then even if block 655 must loop a number of times, it is presumed the vehicle 12 will eventually become stationary to allow user(s) in ingress and/or egress—e.g., whether the vehicle 12 is operating in a fully-autonomous mode (e.g., level 5), or whether a user is operating the vehicle 12 in a non-autonomous mode (e.g., level 0) or a partially autonomous mode (e.g., levels 1-4). In other examples, where an indication is received by a user touching sensor 90 (block 635), by a user operating HMI 58 (in vehicle 12) (block 645), by a person outside vehicle 12 actuating switch 62 (block 645), by a remotely-located person or computer providing a wireless message (block 645), etc., it may be presumed that it is desirable to wait until the vehicle 12 is at a complete stop before electronically actuating the buckle 30. Thus, in each of these scenarios, block 655 may loop back and repeat itself until the vehicle 12 is stationary.

Following block 655, the computer 50 may electronically actuate buckle 30 causing the electro-magnet 76 to be energized, thus causing the actuator 78 to be attracted toward the electro-magnet 76 and drive the locking feature 70 from the opening 74 of clip 14—thereby causing the tongue 64 of clip 14 to be released and ejected from buckle 30 by the ejector mechanism 86, as described above. Thereafter, process 600 may end.

Other examples of process 600 are also possible. For example, when the emergency switch 62 (block 645) and the vehicle 12 is determined to be stationary (block 655), computer 50 may be configured to electronically actuate all buckles (e.g., 30-36) which are coupled thereto. For example, it may be determined that emergency personnel (e.g., emergency medical technicians, police or fire personnel, etc.) are attempting to remove users who could be injured from the vehicle 12. Other scenarios are possible wherein all buckles are decoupled simultaneously or nearly so.

In one example, the buckles 30-36 are provided an electrical power signal via auxiliary power source 54. In this manner, if a fault occurs between the primary power source and the electronic seatbelt system 10, power source 54 still may be available to enable user egress. Power source 54 may be rechargeable by the vehicle's electrical system (e.g., following a vehicle ignition event and while the vehicle 12 is powered ON).

In another example, the computer 50 may be coupled to only some of the buckles 30-36. In one example, computer 50 is coupled to seatbelt buckles other than the driver and front passenger seats (S4, S3)—e.g., in this manner, the system 10 is particularly adapted for retaining minors or children in rear seats S1, S2. Of course, in other vehicles, this also may include third row seating (not shown in FIG. 1).

In at least one example, any instruction from mobile device 124 and/or remote server 128 may be encrypted using any suitable encryption technology known to skilled artisans. For example, a payload of the message may include the instruction in an encrypted format. Further, computer 50 may be programmed to receive the message payload in its encrypted form from computer 52, perform decryption, authenticate the source of the message (e.g., using an identifier), and then execute the instruction based on the decryption and authentication. In this context, authentication may occur when the identifier associated with the message is stored on a list of authorized users (e.g., stored in memory 96). Of course, examples exist where the message identify may not be encrypted as well.

In addition, instructions sent over the wireless communication network 132 may be received at computer 52 in any suitable format. Non-limiting examples include: SMS messages, voice calls, packet data calls, satellite calls, etc.

In at least one example, the computer 50 may not be required to determine that the vehicle 12 is stationary prior to actuating electronically the buckle(s) 30-36. For example, scenarios may exist where it may be desirable to release at least one of buckles 30-36 when the vehicle 12 is moving. Thus, for example, process 600 could proceed from block 630 directly to block 660 (or from block 665 directly to block 655, or from block 640 directly to block 655, or from block 645 directly to block 655, etc.).

In another example, process 600 includes vehicle 12 operating in an autonomous mode—e.g., prior to blocks 630-660. For example, computer 50 may receive an indication (e.g., an instruction, message, etc.) over bus 110 indicating that one or more vehicle features are operating autonomously. In one example, computer 50 receives an indication that vehicle 12 is operating in a fully-autonomous mode (e.g., level 5)—e.g., operating in this particular mode may be user-initiated (e.g., at the outset of the user's trip) or the vehicle 12 may be an autonomous taxi vehicle, autonomous school bus, or the like.

In another example, process 600 includes computer 50 receiving an indication that the vehicle 12 has arrived at a predetermined destination, sending a message to a user, and then independently receiving an indication to decouple the buckle 30 (e.g., from mobile device 124 or server 128). For example, a parent may manually fasten clip/buckle pair 14, 30 to secure their minor child in a fully-autonomous taxi vehicle. The vehicle 12 may drive a child to a predetermined destination (e.g., according to stored destination data in memory 96); this destination data could be provided via mobile device 124 (or HMI 58). Upon reaching the destination, computer 50 may transmit a first or request message to the parent (e.g., a wireless message via computer 52) to request authorization to electronically actuate the buckle. Upon receiving the request message via mobile device 124, the parent may respond with a second or response message (e.g., another wireless message sent to vehicle 12)—the response message including an instruction in the payload to electronically actuate the buckle 30. And upon receiving the response message at computer 50 (e.g., again via computer 52), the computer 50 may electronically actuate the buckle 30 to release the child from the clip/buckle pair 14, 30. In this manner, the parent may have more control over the safe arrival of their child (e.g., at the predetermined destination).

Thus, there has been described an electronic seatbelt system for a vehicle that includes at least one computer that is programmed to determine when to release a seatbelt clip from a seatbelt buckle. The computer may make the determination based on one or more criteria; non-limiting examples of criteria include: receiving and authenticating sensor data from a sensor located on the buckle, receiving an indication from a switch or user input located at the vehicle, and determining that the vehicle has arrived at a predetermined destination.

In general, the computing systems and/or devices described may employ any of a number of computer operating systems, including, but by no means limited to, versions and/or varieties of the Ford SYNC® application, AppLink/Smart Device Link middleware, the Microsoft® Automotive operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

The processor is implemented via circuits, chips, or other electronic component and may include one or more microcontrollers, one or more field programmable gate arrays (FPGAs), one or more application specific circuits ASICs), one or more digital signal processors (DSPs), one or more customer integrated circuits, etc. the processor can receive the data from the sensors and determine, from the data, └what the processor is supposed to do┘. The processor may be programmed to process the sensor data. Processing the data may include processing the video feed or other data stream captured by the sensors to determine the roadway lane of the host vehicle and the presence of any target vehicles. As described below, the processor instructs vehicle components to actuate in accordance with the sensor data. The processor may be incorporated into a controller, e.g., an autonomous mode controller.

The memory (or data storage device) is implemented via circuits, chips or other electronic components and can include one or more of read only memory (ROM), random access memory (RAM), flash memory, electrically programmable memory (EPROM), electrically programmable and erasable memory (EEPROM), embedded MultiMediaCard (eMMC), a hard drive, or any volatile or non-volatile media etc. The memory may store data collected from sensors.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A computer, programmed to:
receive data from a sensor located on a vehicle seatbelt buckle;
authenticate the data; and
based on the authentication, actuate the buckle to release a clip therefrom.

2. The computer of claim 1, wherein the data is biometric data.

3. The computer of claim 2, wherein the biometric data includes a digital representation of a human fingerprint.

4. The computer of claim 1, wherein the data is pressure data associated with an applied pressure on a surface of the sensor.

5. The computer of claim 1, wherein the computer further is programmed to store at least one sensor data parameter in memory, wherein authentication further comprises comparing the data to the at least one sensor data parameter.

6. The computer of claim 1, wherein the actuation of the buckle includes the computer providing an electrical signal to the buckle to energize an attracting member therein.

7. A computer, programmed to:
receive a message associated with an electronic seatbelt buckle in a vehicle from one of: a vehicle switch, a mobile device, or a remotely-located server; and
in response to receiving the message, actuate the buckle to release a clip therefrom.

8. The computer of claim 7, wherein the switch is located on an exterior surface of the vehicle.

9. The computer of claim 7, wherein the switch is located at a human-machine interface within the vehicle.

10. The computer of claim 7, wherein the message is received via a wireless communication network.

11. The computer of claim 7, wherein the computer further is programmed to, prior to receiving the message, receive an indication that the vehicle is operating in an autonomous mode.

12. The computer of claim 7, wherein actuating the buckle includes providing an electrical signal to the buckle to energize an attracting member therein.

13. The computer of claim 7, wherein the computer further is programmed to actuate the buckle using an auxiliary power source located on the vehicle.

14. A computer, programmed to:
determine a vehicle is located at a predetermined destination; and
in response to the determination, actuate an electronic seatbelt buckle in the vehicle to release a clip therefrom.

15. The computer of claim 14, wherein the computer further is programmed to, prior to the determination, receive an indication that the vehicle is operating in an autonomous mode.

16. The computer of claim 14, wherein the computer further is programmed to, prior to the determination, store destination data in memory and compare current vehicle location data with the destination data.

17. The computer of claim 14, wherein actuating the buckle includes providing an electrical signal to the buckle to energize an attracting member therein.

18. The computer of claim 14, wherein the computer further is programmed to, prior to actuating the buckle, send a first message to a mobile device to request authorization to actuate the buckle.

19. The computer of claim 18, wherein the computer further is programmed to, prior to actuating the buckle, receive a second message from the mobile device that includes an instruction to actuate the buckle.

20. The computer of claim 14, wherein the computer further is programmed to actuate the buckle using an auxiliary power source located on the vehicle.
